(19) United States
(12) Patent Application Publication
(10) Pub. No.: US 2007/0051840 A1
(43) Pub. Date: Mar. 8, 2007

(54) Seatbelt retractor and seatbelt apparatus

(75) Inventors: Koji Hiramatsu, Tokyo (JP); Miwa Morimoto, Tokyo (JP)

Correspondence Address: FOLEY AND LARDNER LLP;SUITE 500, 3000 K STREET NW, WASHINGTON, DC, 20007, US

(73) Assignee: TAKATA CORPORATION

(21) Appl. No.: 11/512,156

(22) Filed: Aug. 30, 2006

(30) Foreign Application Priority Data
Sep. 6, 2005 (JP) 2005-257407

(51) Int. Cl. B60R 22/46

(52) U.S. Cl. 242/374

(57) ABSTRACT

The disclosed seatbelt retractor and seat belt apparatus may comprise a spool for retracting a seatbelt, a torsion bar arranged radially inside of the spool, a pretensioner for generating a rotational drive force for rotating the spool in a seatbelt retracting direction during a state of emergency; and a relay locking mechanism. The relay locking mechanism may be configured for locking the spool so as to restrict the rotation of the spool in the seatbelt withdrawing direction in the normal state and configured for unlocking the spool while locking an axial side of the torsion bar so as to restrict the rotation of the torsion bar in the seatbelt withdrawing direction in the state of emergency.

### BACKGROUND

The present invention relates to a seatbelt retractor that retracts a seatbelt and, more specifically, to a seatbelt retractor having an energy absorption mechanism (hereinafter “EA mechanism”) which absorbs the inertial energy applied to a passenger when constraining the movement of the passenger by locking the seatbelt in the case of an emergency, and relates to a seatbelt apparatus provided with the seatbelt retractor.

A seatbelt apparatus provided on a seat of a vehicle is an important apparatus used as a device for constraining a sudden movement of a passenger due to the deceleration that occurs upon a collision of the vehicle, and thus ensures the security of the passenger's body.

The seatbelt apparatus generally includes a seatbelt (such as a webbing), a seatbelt retractor, a buckle device, and so on.

The retractor retracts the seatbelt that is wound around a winding member (such as a spool) inward by a spring force and accommodates the seatbelt normally in the retracted state. When the passenger wears the seatbelt, he or she withdraws the seatbelt accommodated in the retractor by pulling a tongue plate provided at one end of the seatbelt opposite from the winding side, and engages the tongue plate with a buckle device provided in the vicinity of the seat so that the passenger wears the seatbelt.

The retractor configured in this manner prevents the withdrawal of the seatbelt from the winding member upon a collision that generates an impact and constrains the passenger's body, which is apt to move suddenly forward, by the locked seatbelt. Here, in order to constrain the passenger's body further, particularly in the case of sudden deceleration of the vehicle, a pretensioner and a locking mechanism are normally provided.

The pretensioner serves to eliminate the loosening of the seatbelt to improve a force of constraint of the seatbelt when an acceleration sensor detects the fact that the vehicle is brought into a state of sudden deceleration. For example, there are various systems for eliminating the loosening of the seatbelt, such as a system in which the loosening of the seatbelt is eliminated by reducing the longitudinal length of an expanding structure entirely by causing a gas generating device to generate gas in response to a detection signal from the acceleration sensor, thus expanding a bag-shaped member; a system for eliminating the loosening of the seatbelt by causing a piston to slide in a cylinder by the gas generated from a gas generating device and rotating the spool in the retracting direction via a pinion; and so on.

The locking mechanism is provided with a locking base that rotates with the spool. In response to the detection signal from the acceleration sensor, a locking member, or pawl, provided on the locking base is engaged with inner teeth provided on a fixed-side member of the vehicle, such as a frame of the retractor or the like, so that the rotation of the locking base and the spool in the withdrawing direction can be restricted.

On the other hand, when the forward movement of the passenger is suddenly constrained at the time of sudden deceleration of the vehicle or the like as described above, an impact force generated by a reaction of being constrained is applied to a chest region or the like of the passenger via the seatbelt. In order to alleviate the impact force applied to the passenger, a method of employing a mechanism for absorbing impact energy applied to the passenger is already known in which a predetermined tensile load of the seatbelt is maintained while applying at least a certain reeling-out resistance to the seatbelt immediately after being locked and, in this state, reeling out the seatbelt by a predetermined length (the “EA” mechanism).

In this method, a shaft, or torsion bar that can be plastically deformed is arranged inside the spool around which the seatbelt is wounded. One side of the torsion bar is coupled to the spool side and the other side thereof is coupled to the locking base side. When the locking base is locked so as not to be capable of rotated by the locking mechanism at the time of sudden deceleration of the vehicle such as the case of an emergency, a tensile force of the seatbelt that constrains the passenger who is apt to move forward by the action of the inertial force acts as a relative rotational force on the one side of the torsion bar with respect to the other side thereof in the seatbelt withdrawing direction. When the relative rotational force reaches or exceeds a certain value, the torsion bar is plastically deformed so that the collision energy is absorbed by the plastic deformation resistance generated. Accordingly, the spool rotates gradually in the seatbelt withdrawing direction irrespective of the locking mechanism being effective so that the seatbelt is reeled out while applying at least a certain tensile force to the seatbelt, thereby alleviating a force applied between the seatbelt and the passenger's body.

For example, as stated in Japanese Unexamined Patent Application Publication No. 2002-120693 (incorporated by reference herein), a seatbelt retractor is provided with a pretensioner, a locking mechanism, and an EA mechanism. When a slight rotation of the spool in the seatbelt withdrawing direction is allowed at the time the EA mechanism is activated, the pretensioner is rotatively coupled with the spool and is already operating in the seatbelt retracting direction, i.e., in the opposite direction.

However, there are problems in the above-described related art. Assuming that a structure is employed in which a portion of the spool on one side (which is coupled to the torsion bar) is coupled to the pretensioner and the locking base (which is locked by the locking mechanism) is coupled to the other side of the torsion bar is employed, even though the pretensioner is operated in the retracting direction of the spool and the locking mechanism locks the rotation of the other side of the torsion bar in the retracting direction, when the one side of the torsion bar is rotated in a twisted manner relative to the other side of the torsion bar, the operation of the pretensioner is directed in the direction opposite to the direction of relative rotation so as to block the relative rotation. In other words, the operation of the EA mechanism is affected by the operation of the pretensioner, and hence it is difficult to secure a stable operation.

It is an object of the present invention to provide a seatbelt retractor that can secure a stable EA operation without being affected by the operation of the pretensioner and to provide a seatbelt apparatus using the same.

### SUMMARY

In order to achieve the above-described object, a seatbelt retractor according to a first embodiment can includes a spool, a torsion bar, a pretensioner, and a relay mechanism. The spool is for retracting a seatbelt. The torsion bar is arranged radially inside of the spool, is coupled to the spool at one axial side, and is torsionally deformed by a relative displacement between the one axial side and the other axial side so as to be capable of absorbing the passenger's kinetic energy. The pretensioner is positioned on the other axial side of the spool for generating a rotational drive force for rotating the spool in the seatbelt retracting direction in a state of sudden deceleration of a vehicle. The relay locking mechanism is for locking the spool with respect to a fixed-side member in the vehicle so as to restrict the rotation of the spool in the seatbelt withdrawing direction in the normal state and for unlocking the spool with respect to the fixed-side member while locking the other axial side of the torsion bar with respect to the fixed-side member so as to restrict the rotation of the torsion bar in the seatbelt withdrawing direction in the state of sudden deceleration of the vehicle.

In the first embodiment, the relay locking mechanism first restricts the rotation of the spool in the seatbelt withdrawing direction in the normal state including a gentle deceleration of the vehicle.

On the other hand, at the time of sudden deceleration of the vehicle, the pretensioner is activated in response to the sudden deceleration. The rotational drive force of the pretensioner causes the spool to rotate in the seatbelt retracting direction via the torsion bar, whereby a force of constraint of the seatbelt with respect to the passenger is improved. Then, the passenger's body pulls the seatbelt with a large force caused by inertia at the time of sudden deceleration of the vehicle and exceeds a predetermined value. Thus, a force in the seatbelt withdrawing direction is significantly applied to the spool. However, the relay locking mechanism unlocks the spool (in other words, one axial side of the torsion bar) with respect to the fixed-side member while locking the other axial side of the torsion bar with respect to the fixed-side member. Accordingly, the one axial side of the torsion bar and the spool coupled thereto are rotationally displaced relative to the other axial side of the torsion bar. Hence, the passenger's kinetic energy can be absorbed by the torsional deformation of the torsion bar, i.e., the EA mechanism. Because the pretensioner is located on the other side of the spool, the operation of the EA mechanism in which the one side of the torsion bar is twisted and rotates relative to the other side is stabilized without being affected by the operation of the pretensioner.

In the manner described above, in the first embodiment, the spool coupled to one axial side of the torsion bar is locked in the normal state. Conversely, at the time of sudden deceleration of the vehicle, only the other axial side of the torsion bar is locked while the one axial side of the torsion bar and the spool coupled thereto are released for the allowing of torsional deformation of the torsion bar. Therefore, the stable EA operation is achieved without being affected by the operation of the pretensioner.

A second embodiment of the present invention can include a locking member positioned on the other axial side of the spool and connected to the other axial side of the torsion bar. The locking member is characterized in that the pretensioner provides a rotational drive force for rotating the spool in the seatbelt retracting direction to the locking member during the state of sudden deceleration of the vehicle. The relay locking mechanism may include a first locking member for locking the locking member to the fixed-side member of the vehicle.

At the time of sudden deceleration of the vehicle, by having the pretensioner provide the rotational drive force to the locking member, the spool can be rotated in the seatbelt retracting direction via the locking member and the torsion bar. The relay locking mechanism, being provided with the first locking member, can lock the locking member with respect to the fixed-side member of the vehicle such as the frame.

A third embodiment of the present invention can be characterized in that the first locking member is a pawl provided rotatably on the locking member for performing a locking operation with respect to the locking member when the relative rotational displacement comes about between the locking member and the spool.

With the provision of the pawl as the first locking member, the pawl can be rotated to lock the locking member when the rotational drive force is applied by the pretensioner to the locking member at the time of sudden deceleration of the vehicle and when the relative rotational displacement comes about between the locking member and the spool.

A fourth embodiment can include a shear pin provided on one of the first locking member and the spool so as to be locked with respect to the other one of those. The shear pin can be sheared according to an applied load. The shear pin may be characterized in that the first locking member is a pawl which performs a locking operation with an urging force applied by a spring in the direction that locks the locking member when the shear pin is sheared.

With the provision of the pawl applied with the urging force by the spring as the first locking member and the mutual engagement between the pawl and the spool with the shear pin, when the pretensioner applies a rotational drive force to the locking member at the time of sudden deceleration of the vehicle and hence a relative rotational displacement comes about between the locking member and the spool, the shear pin is sheared and the pawl is rotated in the locking direction by the urging force applied by the spring. Thus, the locking member achieves the locking operation.

A fifth embodiment of the present invention can be characterized in that the relay locking mechanism can include a second locking member for locking the spool with respect to the fixed-side member of the vehicle.

The spool can be locked with respect to the fixed-side member of the vehicle such as a frame with the second locking member provided on the relay locking mechanism.

A sixth embodiment of the present invention may be characterized in that the second locking member is a pawl rotatably provided on one axial side of the spool for performing the locking operation with respect to the spool according to the deceleration of the vehicle.

With the provision of the pawl as the second locking member, the locking operation with respect to the spool can be performed by rotating the pawl corresponding to a signal from, for example, a sensor sensing the deceleration of the vehicle.

A seventh embodiment may be characterized in that the one axial side of the torsion bar and the spool are coupled so as to be capable of accepting a predetermined amount of relative rotational displacement therebetween. Also, the second locking member may be a pawl for releasing the locking operation with respect to the spool in a state in which the rotational displacement comes about in which the spool rotates relative to the locking member in the seatbelt withdrawing direction.

Accordingly, when the seatbelt is withdrawn in the normal state, because the rotational displacement comes about in which the spool rotates relative to the locking member in the seatbelt retracting direction, the locked state of the spool is released; and hence the seatbelt can be withdrawn easily.

An eighth embodiment of the present invention may be characterized in that the locking member is formed with a cam groove on a surface opposing to the spool. The second locking member can include a camshaft extending from a rotational axis and a cam pin. The cam pin can be engaged with the cam groove for causing the second locking member to rotate via the camshaft along the cam groove when the relative rotational displacement comes about between the spool and the locking member.

Accordingly, when the pretensioner applies the rotational drive force to the locking member in the case of sudden deceleration of the vehicle and hence the relative rotational displacement comes about between the locking member and the spool, the locked state of the spool by the pawl can be released so as to be capable of rotating the one side of the torsion bar relative to the other side thereof.

A ninth embodiment of the present invention can include a spool for retracting a seatbelt, a torsion bar, a locking base, a pretensioner, a first pawl, and a second pawl. The torsion bar is arranged radially inside of the spool, wherein the torsion bar is coupled to the spool at one axial side thereof so as to be capable of accepting a predetermined amount of relative rotational displacement and torsionally deformed by a relative displacement between the one axial side and the other axial side so as to be capable of absorbing a passenger's kinetic energy. The locking base is located on the other axial side of the spool and coupled to the other axial side of the torsion bar. The pretensioner is positioned on the other axial side of the spool for generating a rotational drive force for rotating the spool in the seatbelt retracting direction and is for transmitting the rotational drive force to the locking base in a state of sudden deceleration of a vehicle. The first pawl is rotatably provided on the locking base for being locked with respect to a shear pin formed on the spool in the normal state and is for shearing the shear pin when a relative rotational displacement exceeding the predetermined amount comes about between the locking base and the spool by the operation of the pretensioner to lock the locking base with respect to a fixed-side member of the vehicle by an urging force applied by a spring. The second pawl is rotatably provided on the one axial side of the spool, is provided with a cam mechanism for locking the spool with respect to the fixed-side member of the vehicle according to a deceleration of the vehicle in the normal state, and is for releasing the locking operation with respect to the spool when a relative rotational displacement comes about between the locking base and the spool by the operation of the pretensioner. The ninth embodiment can be characterized in that the cam mechanism may include a camshaft extending from a rotation axis of the second pawl and a cam pin. The cam pin can be engaged with a cam groove formed on the locking base for causing the second locking member to rotate via the camshaft along the cam groove when a relative rotational displacement comes about between the spool and the locking base. The cam mechanism may cause the second pawl to rotate so as to release the locking operation with respect to the spool in a state in which the rotational displacement comes about in which the spool rotates relative to the locking member in the seatbelt withdrawing direction.

In the ninth embodiment, the shear pin is in the unsheared state, which is just-about-not-sheared, in the normal state. The first pawl can be in the unlocked state in which the locking base is not locked with respect to the fixed-side member. At this time, when the second pawl locks the spool with respect to the fixed-side member according to the deceleration of the vehicle, the rotation of the spool in the seatbelt withdrawing direction is restricted.

On the other hand, at the time of sudden deceleration of the vehicle, the pretensioner is activated as a first stage in which the locking base, the torsion bar, and the spool rotate in the seatbelt retracting direction by the rotational drive force, whereby the force of constraint of the seatbelt with respect to the passenger is improved. At this time, the rotational displacement comes about in which the locking base rotates relative to the spool in the seatbelt retracting direction. That is, the rotational displacement comes about in which the spool rotates relative to the locking member in the seatbelt withdrawing direction, whereby the second pawl releases the locking operation with respect to the spool by the cam mechanism. Then, with the subsequent operation of the pretensioner, the shear pin is sheared by the relative rotational displacement exceeding the predetermined amount coming about between the locking base and the spool (this predetermined amount corresponds to the amount of relative rotational displacement accepted by the coupling between the spool and the torsion bar). The first pawl locks the locking base with respect to the fixed-side member of the vehicle by the urging force applied by the spring.

Consequently, the one axial side of the torsion bar coupled to the spool is rotationally displaced relative to the other axial side thereof (which is fixed to the locking base locked by the first pawl), and the passenger's kinetic energy is absorbed by the torsional deformation of the torsion bar, the EA mechanism. Because the pretensioner is located on the other axial side of the spool and is coupled to the locking base, the operation of the EA mechanism in which the one side of the torsion bar is twisted and is relatively rotated with respect to the other side thereof is not affected by the operation of the pretensioner, and thus stable operation is secured.

A tenth embodiment of the present invention can include a spool for retracting a seatbelt, a torsion bar, a pretensioner, and a locking member. The torsion bar is arranged radially inside of the spool, can be coupled to the spool at one axial side, and is torsionally deformed by a relative displacement between the one axial side and the other axial side so as to be capable of absorbing the passenger's kinetic energy. The pretensioner is positioned on the other axial side of the spool for generating a rotational drive force for rotating the spool in the seatbelt retracting direction in a state of sudden deceleration of a vehicle and is for locking the other axial side of the torsion bar with respect to the fixed-side member so as to restrict the rotation in the seatbelt withdrawing direction thereof for a predetermined duration. The locking member is for locking the spool with respect to the fixed-side member of the vehicle so as to restrict the rotation thereof in the seatbelt withdrawing direction in the normal state and is for unlocking the spool with respect to the fixed-side member in the state of sudden deceleration of the vehicle.

According to the tenth embodiment, in the normal state, the locking member restricts the rotation of the spool in the seatbelt withdrawing direction.

On the other hand, at the time of sudden deceleration of the vehicle, the pretensioner can be activated in response to the sudden deceleration. The spool is rotated by the rotational drive force via the torsion bar in the seatbelt retracting direction, whereby the force of constraint of the seatbelt with respect to the passenger is improved. Subsequently, the passenger's body pulls the seatbelt by a large force exceeding the predetermined value by inertia at the time of sudden deceleration of the vehicle, and the force in the seatbelt withdrawing direction is largely applied to the spool. However, an engaging member unlocks the spool (in other words, the one axial side of the torsion bar) with respect to the fixed-side member at the time of sudden deceleration of the vehicle, while the pretensioner locks the other axial side of the torsion bar with respect to the fixed-side member for a predetermined duration. Accordingly, the one axial side of the torsion bar and the spool coupled thereto are rotationally displaced relative to the other axial side of the torsion bar, and the passenger's kinetic energy can be absorbed by the torsional deformation of the torsion bar, the EA mechanism. Because the pretensioner is located on the other side of the spool, the operation of the EA mechanism in which the one side of the torsion bar is twisted and relatively rotated with respect to the other side can be stabilized without being affected by the operation of the pretensioner.

As described thus far, in the tenth embodiment, the spool coupled to the one axial side of the torsion bar is locked in the normal state. Conversely, at the time of sudden deceleration of the vehicle, only the other axial side of the torsion bar is locked while the one axial side of the torsion bar and the spool coupled thereto are released for the allowing of torsional deformation of the torsion bar. Therefore, the stable EA operation is achieved without being affected by the operation of the pretensioner.

An eleventh embodiment of the present invention can be characterized in that the pretensioner includes a gas generator, a conduit in which gas generated by the gas generator is blown in, a plurality of balls arranged in the conduit and accelerated by the gas; a clutch to be coupled to the other axial side of the torsion bar; and a mechanism for converting the movement of the accelerated balls into a force for rotating the torsion bar.

Accordingly, when the pretensioner is activated at the time of sudden deceleration of the vehicle, the rotational drive force in the seatbelt retracting direction is applied to the other axial side of the torsion bar via the locking member or the like. Then, the restriction of rotation of the other axial sides of the locking member and the torsion bar in the seatbelt withdrawing direction can be maintained for a certain duration until the gas pressure in the conduit is lowered.

A twelfth embodiment of the present invention can include a spool for retracting a seatbelt, a torsion bar, a locking base, a first pawl, a second pawl, a pretensioner, and a shear shaft. The torsion bar is arranged radially inside of the spool, is coupled to the spool at one axial side so as to be capable of accepting a predetermined amount of relative rotational displacement, and is torsionally deformed by a relative displacement between the one axial side and the other axial side so as to be capable of absorbing the passenger's kinetic energy. The locking base is located on the other axial side of the spool and coupled to the other axial side of the torsion bar. The first pawl is rotatably provided on the locking base for locking the locking base with respect to the fixed-side member of the vehicle according to the deceleration of a vehicle. The second pawl is rotatably provided on one axial side of the spool for locking the spool with respect to the fixed-side member of the vehicle according to the deceleration of the vehicle. The pretensioner is located on the other axial side of the spool for generating a rotational drive force to cause the spool to rotate in the seatbelt retracting direction and is for transmitting the rotational drive force to the locking base in a state of sudden deceleration of the vehicle. The shear shaft is provided so as to penetrate through the locking base and the spool in the axial direction as a common rotational axis which is coupled respectively to the first pawl and the second pawl. This embodiment is provided with a presumptive shearing portion which is to be sheared according to an applied load. The presumptive shearing portion of the shear shaft is set to have a shearing strength to maintain the substantially unsheared state so as to keep a coupled state between the first pawl and the second pawl in the normal state, and is set to be sheared so as to release the coupled state between the first pawl and the second pawl when the pretensioner is operated in the state of sudden deceleration of the vehicle on the basis of a force applied to the spool by the pretensioner to cause the spool to rotate in the seatbelt retracting direction.

In the twelfth embodiment, the presumptive shearing portion of the shear shaft is in the substantially unsheared state, which is just-about-not-sheared, in the normal state. The spool is coupled to the locking base via the shear shaft while the first pawl and the second pawl are connected so as to be interlocked with each other. At this time, when the first pawl locks the locking base and the second pawl locks the spool respectively to the fixed-side member of the vehicle according to the deceleration of the vehicle, the rotation of the spool in the seatbelt retracting direction is impaired.

On the other hand, at the time of sudden deceleration of the vehicle, the pretensioner is activated in response to the sudden deceleration. The locking base is rotated in the seatbelt retracting direction by the rotational drive force thereof to improve the force of constraint of the seatbelt with respect to the passenger. The presumptive shearing portion of the shear shaft is sheared by the rotational drive force of the pretensioner at the time of sudden deceleration of the vehicle to release the coupling between the second pawl on the one axial side and the first pawl on the other axial side, thereby releasing the coupling between the locking base and the spool. Subsequently, the passenger's body pulls the seatbelt with a large force exceeding the predetermined value by inertia at the time of sudden deceleration of the vehicle, and hence a large force is applied to the spool in the seatbelt withdrawing direction. However, because the coupling between the locking base and the spool is already released, the one axial side of the torsion bar coupled to the spool is rotationally displaced relative to the other axial side (which is fixed to the locking base). Thus, the torsional deformation of the torsion bar absorbs the passenger's kinetic energy, i.e., the EA mechanism. Because the pretensioner is located on the other axial side of the spool and is coupled to the locking base, the operation of the EA mechanism in which the one side of the torsion bar is twisted and relatively rotated with respect to the other side can secure stable operation without being affected by the operation of the pretensioner.

As described thus far, according to the twelfth embodiment, both of the spool coupled to the one axial side of the torsion bar and the locking base coupled to the other axial side of the torsion bar are locked in the normal state. Conversely, only the other axial side of the torsion bar is locked while the one axial side of the torsion bar and the spool coupled thereto are released for the allowing of the torsional deformation of the torsion bar at the time of sudden deceleration of the vehicle. Therefore, the stable EA operation is achieved without being affected by the operation of the pretensioner.

A thirteenth embodiment of the present invention can be characterized in that the first pawl is applied with an urging force in the locking direction of the locking member by a spring when the shear shaft is sheared, whereby the locking operation is achieved.

Because the urging force can be constantly applied to the first pawl and the shear shaft for controlling the rotation of the first pawl is sheared in a second stage at the time of the sudden deceleration of the vehicle, the pawl may be rotated in the locking direction with the urging force applied by the spring, whereby the locking operation of the locking member is achieved.

A fourteenth embodiment of the present invention can be characterized in that the second pawl releases the locking operation with respect to the spool when the shear shaft is sheared.

Accordingly, the spool coupled to the one axial side of the torsion bar is rotationally displaced relative to the locking base coupled to the other axial side of the torsion bar in the second stage of the sudden vehicle deceleration of the vehicle so that the torsional deformation of the torsion bar absorbs the passenger's kinetic energy.

A fifteenth embodiment of the present invention can be characterized in that the locking member is formed with a cam groove on a surface opposing the spool. The shear shaft includes a cam pin which is to be engaged with the cam groove for causing the second pawl to be rotated via the shear shaft along the cam groove when the relative rotational displacement comes about between the spool and the locking member. The presumptive shearing portion of the shear shaft is provided on the side of the first pawl with respect to a joint portion of the shear shaft with respect to the cam pin.

Accordingly, when the relative rotational displacement comes about between the locking member and the spool in the second stage of the sudden deceleration of the vehicle, the locking of the spool by the first pawl is released to allow the relative rotation of the one side of the torsion bar with respect to the other side thereof.

A seatbelt apparatus according to a sixteenth embodiment of the present invention can include a seatbelt for constraining a passenger, a seatbelt retractor for withdrawably retracting one side of the seatbelt, a tongue provided on the seatbelt, and a buckle device for causing the passenger to wear the seatbelt by being engaged with the tongue. This embodiment is characterized in that the seatbelt retractor includes a spool for retracting the seatbelt; a torsion bar arranged radially inside of the spool; the torsion bar being coupled to the spool at one axial one side thereof and torsionally deformed by a relative displacement between the one axial side and the other axial other side so as to be capable of absorbing the passenger's kinetic energy; a pretensioner positioned on the other axial side of the spool for generating a rotational drive force for rotating the spool in the seatbelt retracting direction in a state of sudden deceleration of the vehicle; and a relay locking mechanism for locking the spool with respect to a fixed-side member in the vehicle so as to restrict the rotation of the spool in the seatbelt withdrawing direction in the normal state and for unlocking the spool with respect to the fixed-side member while locking the other axial side of the torsion bar with respect to the fixed-side member so as to restrict the rotation of the same in the seatbelt withdrawing direction in the state of sudden deceleration of the vehicle.

In the sixteenth embodiment, in the normal state, the relay locking mechanism provided on the seatbelt retractor first restricts the rotation of the spool in the seatbelt withdrawing direction.

On the other hand, in case of the sudden deceleration of the vehicle, the pretensioner is activated in response to the sudden deceleration, and the spool rotates in the seatbelt retracting direction via the torsion bar by the rotational drive force thereof, whereby the force of constraint of the seatbelt with respect to the passenger is improved. Thereafter, the passenger's body pulls the seatbelt by a large force exceeding a predetermined value by inertia at the time of sudden deceleration of the vehicle and a large force in the seatbelt withdrawing direction is applied to the spool. However, the relay locking mechanism releases the locking of the spool (in other words, the one axial side of the torsion bar) with respect to the fixed-side member while locking the other axial side of the torsion bar with respect to the fixed-side member at the time of sudden deceleration of the vehicle. Accordingly, the one axial side of the torsion bar and the spool coupled thereto are rotationally displaced relative to the other axial side of the torsion bar, and hence the passenger's kinetic energy can be absorbed by the torsional deformation of the torsion bar, i.e., the EA mechanism. Because the pretensioner is located on the other side of the spool, the operation of the EA mechanism in which the one side of the torsion bar is twisted and relatively rotated with respect to the other side is stabilized without being affected by the operation of the pretensioner.

As described thus far, according to the sixteenth embodiment, the spool is coupled to the one axial side of the torsion bar is locked in the normal state. Conversely, only the other axial side of the torsion bar is locked while the one axial side of the torsion bar and the spool coupled thereto are released for the allowing of the torsional deformation of the torsion bar at the time of sudden deceleration of the vehicle. Therefore, the stable EA operation is achieved without being affected by the operation of the pretensioner.

According to the various embodiments of the present invention, a stable EA operation may be achieved without being affected by the operation of the pretensioner.

It is to be understood that both the foregoing general description and the following detailed description are exemplary and explanatory only, and are not restrictive of the invention as claimed.

### BRIEF DESCRIPTION OF THE DRAWINGS

The features, aspects, and advantages of the present invention will become apparent from the following description, appended claims, and the accompanying exemplary embodiments shown in the drawings, which are briefly described below.

FIG. 1 is a drawing showing a seatbelt apparatus according to an embodiment of the present invention.

FIG. 2 is a vertical cross-sectional view showing a seatbelt retractor according to a first embodiment of the present invention.

FIG. 3 is a drawing showing a configuration of a main pawl on the side of a spool according to the first embodiment of the present invention.

FIG. 4 is a drawing showing a configuration of a sub pawl on a locking base side according to the first embodiment of the present invention.

FIG. 5 is a drawing showing the operation and effects of the seatbelt retractor in the normal state according to the first embodiment of the present invention.

FIG. 6 is a drawing showing the operation and the effects of the seatbelt retractor at the time of sudden deceleration of a vehicle according to the first embodiment of the present invention.

FIG. 7 is a cross-sectional view of the pretensioner taken along the cross sectional line VII-VII in FIG. 2, showing a state before the operation of the pretensioner.

FIG. 8 is a cross-sectional view of the pretensioner taken along the cross sectional line VII-VII in FIG. 2, showing a state immediately after the operation of the pretensioner.

FIG. 9 is a drawing showing the line of pressure characteristics of the pretensioner.

FIG. 10 is a drawing showing a configuration in which a centrifugal pawl is provided on the locking base.

FIG. 11 is a vertical cross-sectional view showing the schematic structure of the seatbelt retractor according to a second embodiment of the present invention.

FIG. 12 is a drawing showing a camshaft around a distal end according to the second embodiment of the present invention.

FIG. 13 is a drawing showing the operation and effects of the seatbelt retractor in the normal state according to the second embodiment of the present invention.

FIG. 14 is a drawing showing the operation and effects of the seatbelt retractor at the time of sudden deceleration of the vehicle according to the second embodiment of the present invention.

### DETAILED DESCRIPTION

Referring now to the drawings, embodiments of the present invention will be described. The embodiments are examples in which the present invention is applied to a seatbelt apparatus of a motor vehicle.

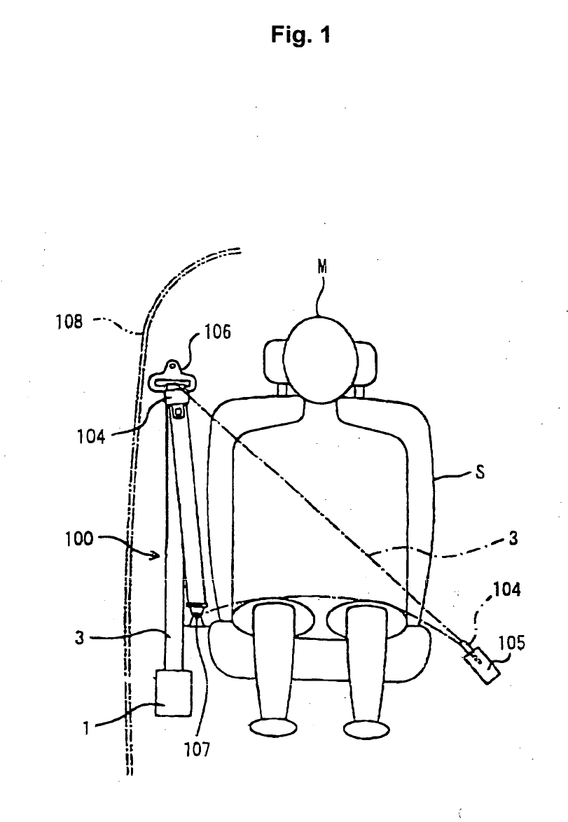

FIG. 1 is a front view of a general configuration of a seatbelt apparatus provided with a seatbelt retractor according to an embodiment of the present invention shown together with a passenger.

In FIG. 1, a seatbelt apparatus 100 can be arranged in a vehicle body 108 of a vehicle and can include a seatbelt 3 for constraining a passenger M on a seat S; a seatbelt retractor 1 for retracting one side of the seatbelt 3 so as to be capable of being withdrawn; a tongue 104 slidably provided on the seatbelt 3; and a buckle device 105 which engages the tongue 104.

The seatbelt 3 may be retracted by the seatbelt retractor 1 at one side, can be passed through a shoulder anchor 106 at a midsection, and can be connected to a vehicle body 108 side by a fixture 107 at an end on the other side.

The seatbelt retractor according to the first embodiment will be described below.

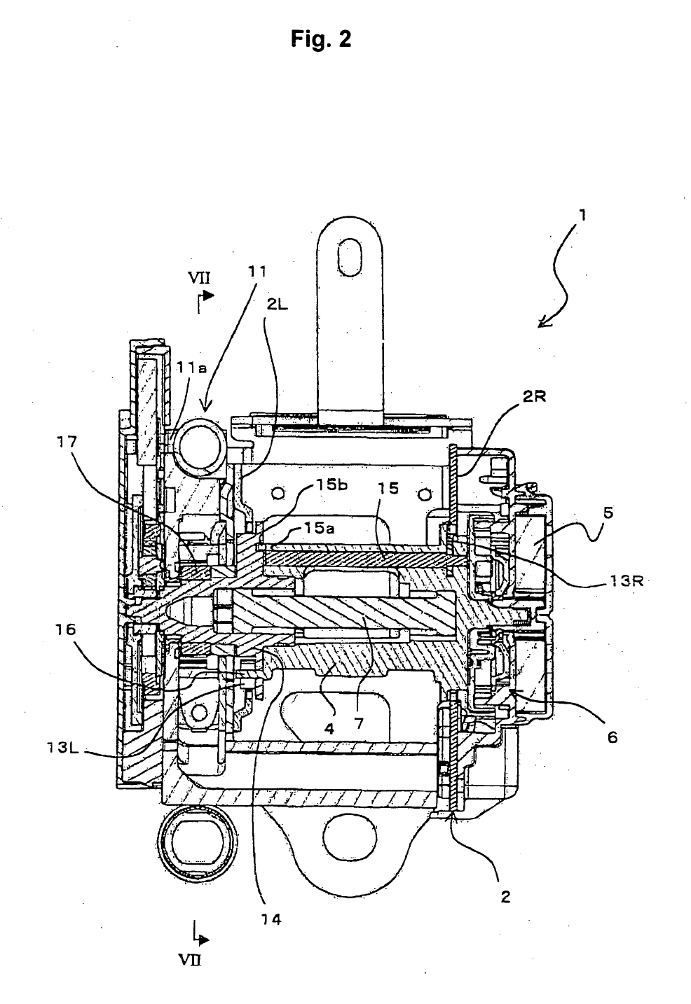

FIG. 2 is a vertical cross-sectional view showing a general schematic structure of the seatbelt retractor 1 according to the first embodiment. In FIG. 2, the seatbelt retractor 1 may include a frame 2, a spool 4, a deceleration sensor, a lock activation mechanism 6, a torsion bar 7, a spiral spring 5, a main pawl 13R, a locking base 14, a sub pawl 13L, a pretensioner 11, and a camshaft 15. The frame 2 is of an angular C-shape having two parallel side walls 2L, 2R and a back wall (not shown) which extends so as to couple the two parallel side walls. The spool 4 is rotatably supported between both side walls 2L, 2R of the frame 2 for retracting the seatbelt 3 (not shown in FIG. 2). The deceleration sensor (not shown) senses a gentle deceleration of a vehicle generated upon a light collision of the vehicle and is activated. The lock activation mechanism 6 is activated by the deceleration sensor for restricting at least a rotation of the spool 4 in the belt withdrawing direction. The torsion bar 7 loosely fits and penetrates radially inside the spool 4 in the axial direction. The torsion bar 7 is coupled to the spool 4 at one axial side thereof (the right side in FIG. 2) so as to allow relative rotational displacement by a predetermined amount (as will be described in detail later) and hence torsionally deformed by the relative displacement between the one axial side and the other axial side (the left side in FIG. 2), thereby being capable of absorbing the kinetic energy of the passenger. The spiral spring 5 may apply an urging force to the spool 4 constantly in the belt retracting direction. The main pawl 13R is pivotably held by the spool 4 on the one axial side thereof for locking the spool 4 with respect to the frame 2 according to the deceleration of the vehicle. The locking base 14 is rotatably supported by the frame 2 on the other side of the torsion bar 7 and the spool 4 and is fixed to the torsion bar 7 on the other axial side thereof. The sub pawl 13L is pivotably held by the locking base 14 for locking the locking base 14 with respect to the side wall 2L of the frame 2 at the time of sudden deceleration of the vehicle. The pretensioner 11 is positioned on the other axial side of the torsion bar 7 and the spool 4 for generating a rotational drive force for causing the spool 4 to rotate in the seatbelt 3 retracting direction by being activated at the time of sudden deceleration of the vehicle such as in the case of an emergency and transmitting the same to the locking base 14 (as is described in detail later). The camshaft 15 can extend from a rotation axis of the main pawl 1 3R and may penetrate through the spool 4 to the locking base 14.

An urging force is constantly applied to the spool 4 in the seatbelt 3 retracting direction by a spring force of the spiral spring 5. A shear pin 16 is formed on the other axial side of the spool 4 and is rotated integrally other than a predetermined amount of relative rotational displacement between the spool 4 and the locking base 14 (a predetermined amount of relative rotational displacement allowed between the spool 4 and the torsion bar 7) which is allowed until the shear pin 16 is sheared as described later.

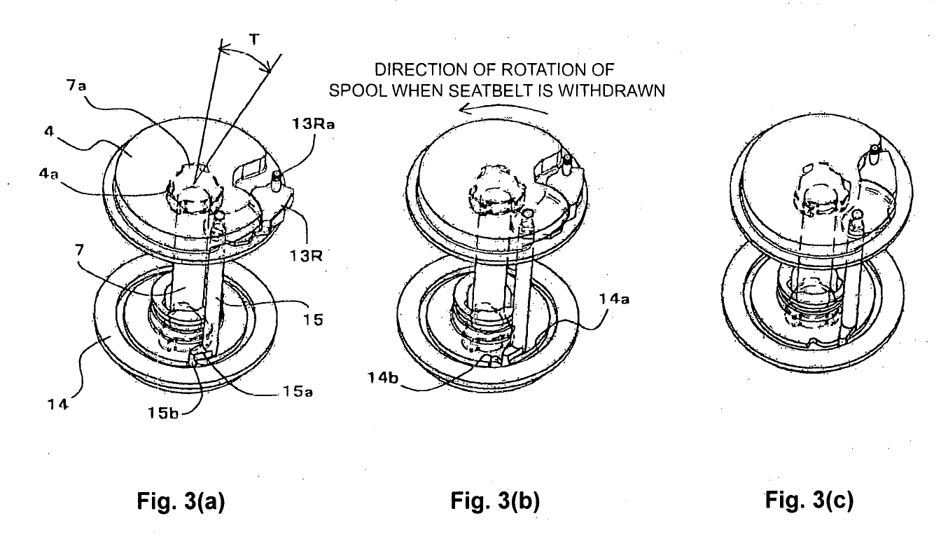

FIG. 3 is a drawing for explaining the structure of the main pawl 13R on the spool 4 side. FIG. 3(a) is a drawing showing the main pawl 13R in the locked state; FIG. 3(b) is a drawing showing the main pawl 13R located in a state between the locked state and the unlocked state; and FIG. 3(c) is a drawing showing the main pawl 13R in the unlocked state.

In FIG. 3, the torsion bar 7 is formed with an external tooth gear 7a having three external teeth on an outer periphery on the one axial side thereof (the upper side in FIG. 3). The spool 4 is formed with an internal tooth gear 4a having three internal teeth on the inner periphery at the center so that the torsion bar 7 and the spool 4 are coupled by engagement between the external tooth gear 7a and the internal tooth gear 4a. Because the spacing between the internal teeth of the internal tooth gear 4a of the spool 4 is larger than the width of each external tooth of the external tooth gear 7a of the torsion bar 7, there exists so-called “backlash” in the connection between the torsion bar 7 and the spool 4. Hence, the torsion bar 7 and the spool 4 are coupled with an allowance of a relative rotational displacement of a predetermined amount T which corresponds to the difference between the spacing among the internal teeth and the width of the external tooth. Because the other axial side of the torsion bar 7 (the lower side in FIG. 3) and the locking base 14 are fixedly coupled to each other, the relative rotational displacement of the same predetermined amount T also freely comes about in the normal state (in the state in which the shear pin 16 is not sheared) between the locking base 14 and the spool 4.

The main pawl 13R is formed with an operating pin 13Ra on a surface opposing the lock activation mechanism 6 (in FIG. 2). The main pawl 13R is formed with a coupling plate 15a and a cam pin 15b at an end of the camshaft 15 extending from the rotational axis of the main pawl 13R on the other axial side. On the other hand, the locking base 14 is formed with a circumferential groove 14a concentric with the rotational axis on a surface of the locking base on the side of the spool 4. A lead-in groove 14b is formed at a part of the circumferential groove 14a on the inner peripheral side.

The cam pin 15b engages the cam groove that is composed of the lead-in groove 14b and the circumferential groove 14a. In the state in which the locking base 14 and the spool 4 are in the relatively rotating positional relation shown in FIG. 3(a), the lead-in groove 14b is formed into an arcuate shape that corresponds to a rotational orbit of the cam pin 15b in the case in which the camshaft 15 is rotated. Therefore, the camshaft 15 and the main pawl 13R can be rotated freely to an extent corresponding to the rotational angle equal to the circumferential angle of the lead-in groove 14b. When the relative rotational displacement between the locking base 14 and the spool 4 comes about, the cam pin 15b causes the camshaft 15 to rotated along the cam groove, and the main pawl 13R rotates toward the inner periphery side of the spool 4.

The rotation of the main pawl 13R will now be described in detail. In the normal state, the locking base 14 and the spool 4 are in the relatively rotating positional relation shown in FIG. 3(a). In this normal state, the main pawl 13R can freely rotate. Therefore, by operating the operating pin 13Ra, the state can be freely switched between a locked state in which the main pawl 13R is projected toward the outer peripheral side of the spool 4 and an unlocked state in which the main pawl is stored in the inner peripheral side of the spool 4 (the unlocked state in this case is not shown in the drawing).

The lock activation mechanism 6 are publicly well-known. The lock activation mechanism moves the operating pin 13Ra shown in FIG. 3 toward the outer periphery by the operation of the deceleration sensor to bring the main pawl 13R to the locked state in which it is projected toward the outer peripheral side with respect to the spool 4 when the vehicle is gently decelerated. Thus, the main pawl 13R is engaged with the internal teeth (not shown) of the side wall 2R of the frame 2 so that the rotation of the spool 4 in the seatbelt withdrawing direction is restricted. When the vehicle is stopped and brought into a stable state, the lock activation mechanism 6 restores the operating pin 13Ra to the inner peripheral side to release the locking of the main pawl 13R.

In addition, when the rotational displacement comes about by the operation of the pretensioner 11 at the time of sudden deceleration of the vehicle in which the spool 4 rotates relative to the locking base 14 in the seatbelt withdrawing direction (i.e., the relative rotational displacement in which the spool 4 is rotated counterclockwise assuming that the locking base 14 is a fixed side in FIG. 3) from a locked state (in which the cam pin 15b enters the lead-in groove 14b and causes the main pawl 13R to project from the spool 4 toward the outer peripheral side), the cam pin 15b is transferred from the lead-in groove 14b to the circumferential groove 14a on the outer peripheral side as shown in FIG. 3(b). Thus, the main pawl 13R is rotated toward the inner peripheral side of the spool 4. When the spool 4 achieves the relative rotational displacement of the predetermined amount T in the seatbelt withdrawing direction with respect to the locking base 14, the main pawl 13R is stored completely in the inner peripheral side of the spool 4 as shown in FIG. 3(c) to achieve the unlocked state.

As described above, the main pawl 13R can be freely switched between the locked state and the unlocked state by the operation of the operating pin 13Ra by the lock activation mechanism 6 in the normal state (including the time of gentle deceleration of the vehicle). When the pretensioner 11 is operated at the time of sudden deceleration of the vehicle, the relative rotational displacement is generated between the locking base 14 and the spool 4 to forcedly bring the main pawl 13R into the unlocked state so that the lock of the spool 4 with respect to the frame 2 can be released.

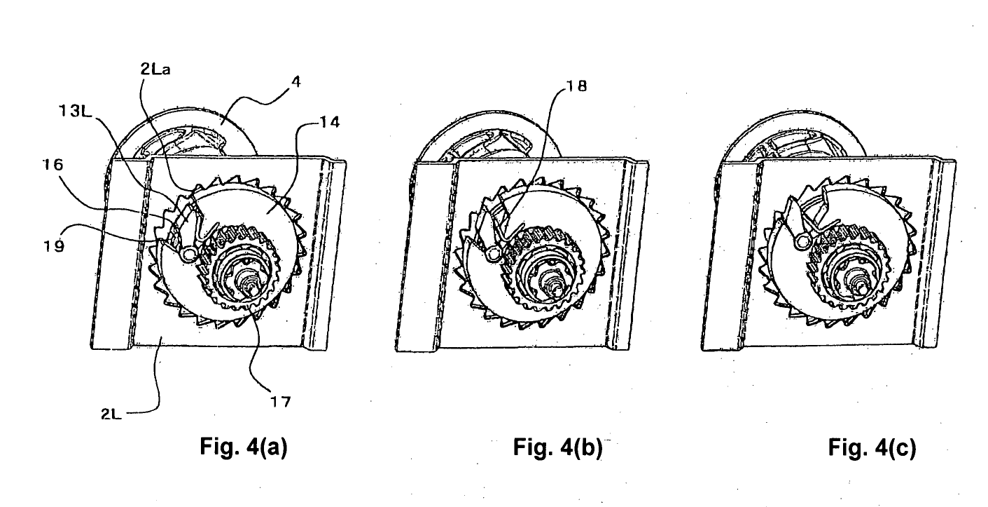

FIG. 4 describes the structure of the sub pawl 13L on the locking base 14 side. FIG. 4(a) is a drawing showing the sub pawl 13L in the unlocked state; FIG. 4(b) is a drawing showing the sub pawl 13L in a state between the unlocked state and the locked state, and FIG. 4(c) is a drawing showing the sub pawl 13L in the locked state.

In FIG. 4, internal teeth 2La with which the sub pawl 13L in the locked state can engage are formed on the side wall 2L of the frame 2 which supports the locking base 14. (Although not specifically shown, similar internal teeth are formed on the side wall 2R of the frame 2 which supports the spool 4.). A pinion 17 for transmitting torque is fixed to the locking base 14 and the rotational drive torque of the pretensioner 11 is transmitted to the pinion 17.

The locking base 14 is provided with a spring member 18 in an arrangement in which an urging force is constantly applied to the sub pawl 13L toward the outer peripheral side of the locking base 14. The shear pin 16 is formed so as to project from the other axial side of the spool 4 (the left side in FIG. 2 and the near side in FIG. 4) and is passed through a through hole 19 of the locking base 14. The shear pin is engaged with the sub pawl 13L so as to work against the urging force applied by the spring member 18. The material and the shape of the shear pin 16 are such that it is sheared according to an applied load and is set to have a shearing strength which resists the urging force applied by the spring member 18 but causes shearing by the rotational drive force of the locking base 14 of the pretensioner 11.

The through hole 19 is formed into a shape such that when the predetermined amount T of the relative rotational displacement comes about between the locking base 14 and the spool 4, the movement of the shear pin 16 is allowed by the same amount (rotational angle) so that the relative rotational displacement between the locking base 14 and the spool 4 and the rotation of the main pawl 13R are not impaired. The movement of the shear pin 16 only causes the sub pawl 13L to rotate slightly toward the outer peripheral side of the locking base 14. In other words, the locked state in which the sub pawl 13L is engaged with the internal teeth 2La of the side wall 2L of the frame 2 to restrict the rotation of the locking base 14 is not achieved unless the shear pin 16 is sheared as will be described later. The engagement of the shear pin 16 with respect to the sub pawl 13L may also be such that an engaging hole is formed on a surface of the sub pawl 13L on the spool 4 side (the back side in FIG. 4) for inserting or engaging the shear pin 16 with the engaging hole in addition to the structure in which the shear pin 16 is engaged with the sub pawl 13L by bringing the shear pin into contact with the outer side surface of the sub pawl as shown in FIG. 4.

The behavior of the sub pawl 13L is such that the shear pin 16 maintains the unlocked state in which the sub pawl 13L is stored in the inner peripheral side of the locking base 14 against the urging force applied by the spring member 18 and the shear pin 16 is not sheared as shown in FIG. 4(a). When the locking base 14 is rotationally driven in the retracting direction by the operation of the pretensioner 11 from this unlocked state so that when the relative rotational displacement of at least the predetermined amount T is generated between the locking base 14 and the spool 4, as shown in FIG. 4(b), the shear pin 16 is sheared and hence broken. Then, the sub pawl 13L is rotated toward the outer peripheral side of the locking base 14 by the urging force applied by the spring member 18. Thus, as shown in FIG. 4(c), the locked state is achieved in which the sub pawl 13L is engaged with the internal teeth 2La of the side wall 2L on the outer peripheral side with respect to the locking base 14.

In the description above, the main pawl 13R, the sub pawl 13L, the camshaft 15 including the cam pin 15b and the coupling plate 15a, the circumferential groove 14a, the lead-in groove 14b, the shear pin 16 and the spring member 18 constitute a relay locking mechanism. The relay locking mechanism is for locking the spool 4 with respect to the fixed-side member of the vehicle to restrain the rotation thereof in the seatbelt withdrawing direction in the normal state and for unlocking the spool 4 with respect to the fixed-side member so as to release the locking thereof and restrain the rotation of the torsion bar 7 in the seatbelt withdrawing direction on the other axial side of the torsion bar 7 in a state of sudden deceleration of the vehicle.

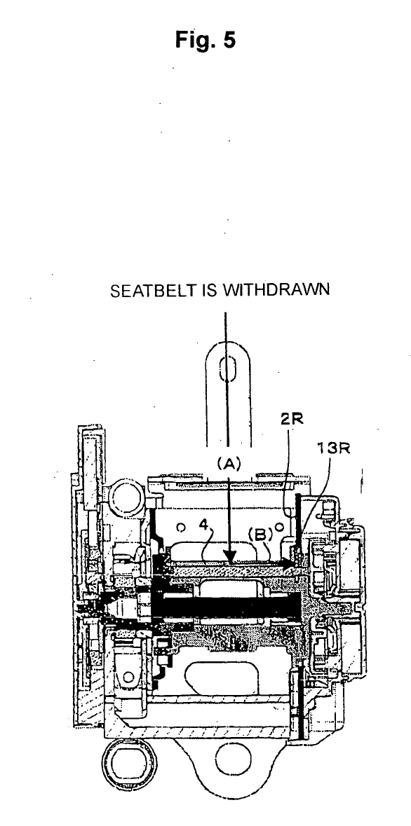

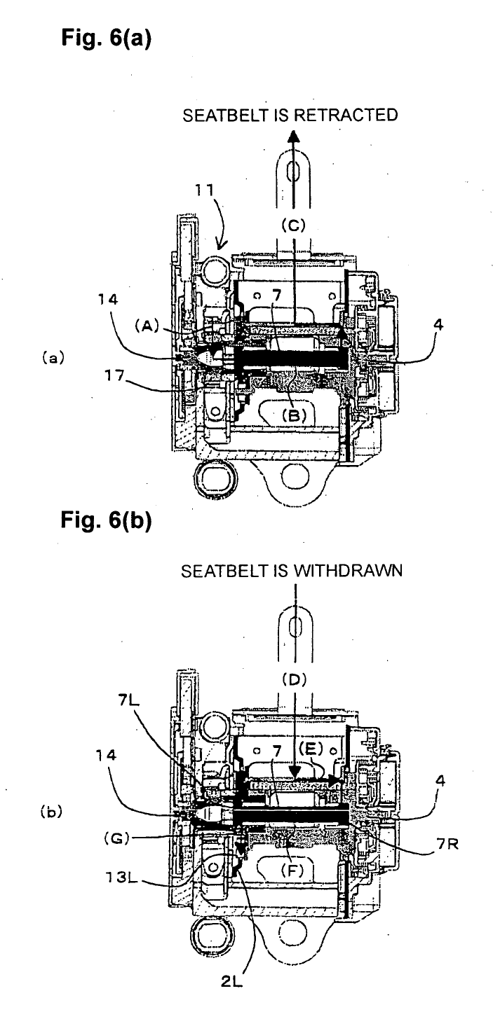

Referring now to FIG. 5 and FIG. 6, the operation and effects of the seatbelt retractor 1 according to the first embodiment, which is configured as described above, will now be described below. The arrows shown in FIG. 5 and FIG. 6 represent a direction of application of the load.

FIG. 5 is a drawing that explains the operation and effects of the seatbelt retractor 1 in the normal state. As shown in FIG. 5, in the normal state, the cam pin 15b is positioned within the circumferential groove of the locking base 14, and hence the main pawl 13R is in the unlocked state. The shear pin 16 is substantially in the unsheared state in which the shear pin 16 is not sheared, and the sub pawl 13L is in the unlocked state. Therefore, the locking base 14, the torsion bar 7 and the spool 4 are integrally freely rotatable. When the seatbelt 3 is not worn, the seatbelt 3 is completely retracted by the urging force applied by the spiral spring 5.

When the seatbelt 3 is withdrawn in the normal speed for wearing the seatbelt (see (A) in FIG. 5), the spool 4 is rotated in the seatbelt withdrawing direction, and the seatbelt 3 is withdrawn smoothly. After a tongue (not shown) provided slidably on the seatbelt 3 is inserted into and engaged with the buckle fixed to the vehicle body, the seatbelt 3 that is excessively withdrawn is retracted by the spool 4 by the urging force applied by the spiral spring 5. Thus, the seatbelt 3 is fitted to the passenger to an extent that does not make the passenger feel an uncomfortable constraint.

When the deceleration sensor is activated by a large deceleration and upon the activation of the deceleration sensor (i.e., an attempt is made suddenly to withdraw the seatbelt 3), the lock activation mechanism 6 rotates the main pawl 13R to be engaged with the internal teeth of the side wall 2R of the frame 2. By the engaging operation of the main pawl 13R, the spool 4 is locked by the frame 2 (see (B) in FIG. 5), and thus the rotation in the seatbelt withdrawing direction is constrained. In this case, only the spool 4 is locked while the locking base 14 and the torsion bar 7 are simply stopped without being applied with a load.

FIG. 6 is a drawing for explaining the operation and effects of the seatbelt retractor 1 at the time of sudden deceleration of the vehicle. As shown in FIG. 6, at the time of sudden deceleration of the vehicle such as in a case of an emergency, the pretensioner 11 is activated according to the sudden deceleration, the rotational drive force is transmitted to the locking base 14 via the pinion 17 (see (A) in FIG. 6(a)). Then, the rotational drive force is transmitted to the spool 4 via the torsion bar 7 (see (B) in FIG. 6(a)) so that the spool 4 rotates a certain predetermined amount in the seatbelt withdrawing direction (see (C) in FIG. 6(a)), and hence the force of constraint of the seatbelt 3 with respect to the passenger is improved.

In a first stage immediately after the sudden deceleration of the vehicle, because a rotational displacement comes about in which the locking base 14 rotates relative to the spool 4 in the seatbelt retracting direction by the rotational drive of the pretensioner 11 (that is, when viewed from the spool 4, the rotational displacement in which the spool 4 is rotated relative to the locking base 14 in the seatbelt withdrawing direction), the main pawl 13R is rotated into the inner peripheral side of the spool 4 and is brought into the unlocked state as described above (see FIG. 3(c)).

When the relative rotational displacement of the locking base 14 with respect to the spool 4 comes about by the rotational drive of the pretensioner 11 by at least the predetermined amount T, the shear pin 16 is sheared and broken. Thus, the sub pawl 13L is brought into the locked state of being engaged with the internal teeth 2La of the side wall 2L on the outer peripheral side with respect to the locking base 14 by the urging force applied by the spring member 18 (see FIG. 4(c)). Therefore, the locking base 14 is locked by the side wall so that the rotation in the seatbelt withdrawing direction is restricted.

Subsequently, in a second stage, the seatbelt 3 is pulled by the passenger's body on the vehicle by the inertia at the time of sudden deceleration of the vehicle by a force of at least a predetermined strength (see (D) in FIG. 6(b)), and a force is significantly applied to the spool 4 in the seatbelt withdrawing direction (see (E) in FIG. 6(b)). However, because the main pawl 13R on the spool 4 side is already in the unlocked state at this moment, a portion 7R of the torsion bar 7 coupled to the spool 4 on the one axial side (the right side in FIGS. 6(a) and (b)) is rotationally displaced relative to a portion 7L (fixed to the locking base 14) locked by the sub pawl 13L (see (G) in FIG. 6(b)) on the other axial side (the left side in FIGS. 6(a) and (b)). The passenger's kinetic energy is absorbed by the torsional deformation of the torsion bar 7 (see (F) in FIG. 6(b)) to limit a load applied to the seatbelt 3.

At this time, because the pretensioner 11 is located on the other axial side of the spool 4 and is coupled to the locking base 14, the operation of the EA mechanism is reliably stabilized without being affected by the operation of the pretensioner 11 in which the portion 7R on the one axial side of the torsion bar 7 is twisted and hence relatively rotated with respect to the portion 7L on the other side.

In the seatbelt retractor 1 in the first embodiment, the spool 4 to be coupled to one axial side of the torsion bar 7 is locked in the normal state. Only the other axial side of the torsion bar 7 is locked for causing the torsional deformation of the torsion bar 7 at the time of sudden deceleration of the vehicle and for releasing the one side of the torsion bar and the spool 4 to be coupled thereto. Therefore, the stable EA operation can be secured without being affected by the operation of the pretensioner 11.

The present invention is not limited to the above-described first embodiment, and various modifications can be made without departing from the scope and technical range of the present invention. For example, it is also possible to lock the locking base 14 for a required duration by the rotational drive force of the pretensioner 11 without using the sub pawl 13L when locking the locking base 14 at the time of sudden deceleration of the vehicle.

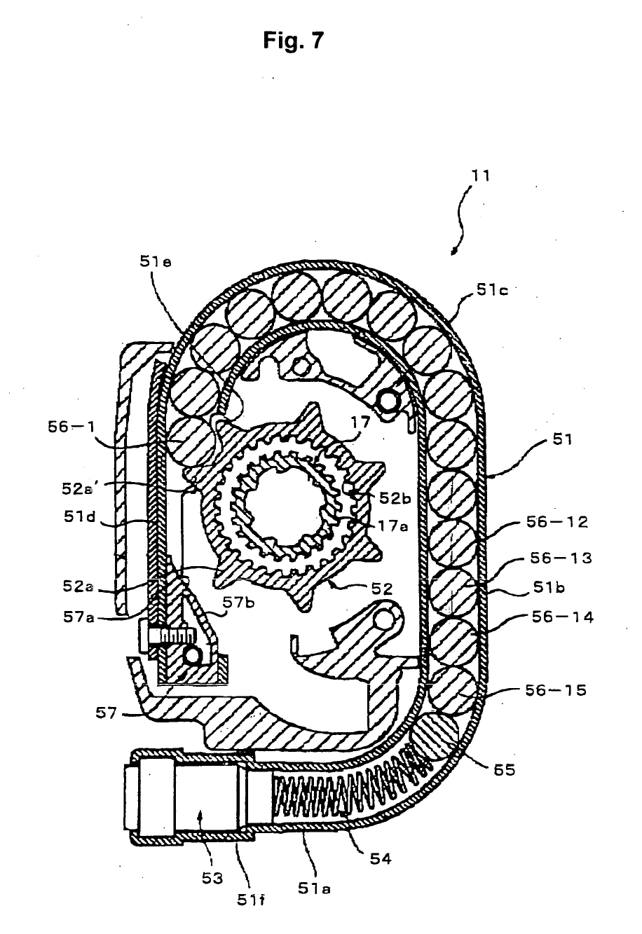

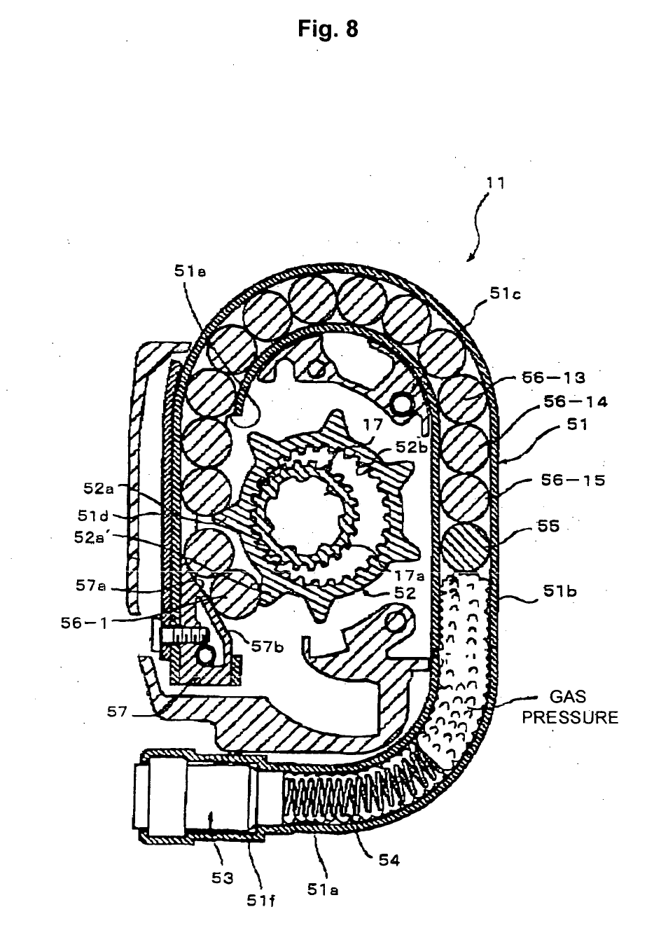

FIG. 7 and FIG. 8 are cross-sectional views of the pretensioner 11 taken along the cross sectional line VII-VII in FIG. 2 for explaining the structure of the modification as described in the previous paragraph. FIG. 7 is a drawing showing a state of the pretensioner 11 before operation and FIG. 8 is a drawing showing a state of the pretensioner 11 immediately after the operation. In FIG. 7 and FIG. 8, the pretensioner 11 includes a conduit 51, a ring gear 52, a gas generator 53, a coil spring 54, a single piston ball 55, a plurality of balls 56, and a guide block 57. The conduit 51, or pipe, is mounted to the outside of the side wall 2L of the frame 2 and curved into substantially a C-shape. The ring gear 52 is arranged on the inner peripheral side of the pipe 51. The gas generator 53 is provided at a proximal end (the lower end in FIG. 7 and FIG. 8) 51a of the pipe 51. The coil spring 54 is connected to the gas generator 53 in the pipe 51. The single piston ball 55 is arranged so as to come into contact with the coil spring 54 in the pipe 51. The plurality of balls 56 (fifteen in this example) is arranged from the piston ball 55 in sequence away from the gas generator 53 in the pipe 51. The guide block 57 is mounted in an end portion of the pipe 51 opposite from the proximal end 5 la of the pipe.

The pipe 51 is formed, for example, by bending a steel pipe into substantially a C-shape which is close to an oval shape, and is mounted to a portion between the side wall 2L of the frame 2 and a pretensioner cover 11a in a sandwiched manner (see FIG. 2). The pipe 51 is curved from the proximal end 51a on the lower side of FIG. 7 and FIG. 8 rightward and upward by about 90 degrees and is continued to a straight portion 51b, and then is continued to a semi-circular section 51c on the upper side of FIG. 7 and FIG. 8. An extremity of the semi-circular section 51c is continued to a straight portion 51d extending downward in FIG. 7 and FIG. 8. A notched portion 51e is formed on a side surface of the straight portion 51d on the inner peripheral side. External teeth 52a (external teeth 52a′ described later) of the ring gear 52 reach into the inner peripheral side of the notched portion 51e.

The ring gear 52 is retained at a fixed position on the inner peripheral side of the pipe 51 by a plurality of shear pins (not shown) formed on the resin-made pretensioner cover 11a (see FIG. 2). In addition, a pinion 17 fixed to the locking base 14 is arranged on the inner peripheral side of the ring gear 52.

An inner peripheral surface of the ring gear 52 is formed with internal teeth 52b which can mesh with the external teeth 17a of the pinion 17. Because the inner diameter of the ring gear 52 is formed to be larger than the outer diameter of the pinion 17, in the state before the operation shown in FIG. 7, a sufficient clearance is secured between the internal teeth 52b of the ring gear 52 and the external teeth 17a of the pinion 17 so that both can be apart from each other without engagement. Therefore, in the normal state, the spool 4 can be rotated freely irrespective of the existence of the pretensioner 11. This is a state in which a clutch mechanism composed of the ring gear 52 and the pinion 17 is in the disconnected state.

An outer peripheral surface of the ring gear 52 is formed with a plurality of external teeth 52a (seven in the example in the drawing), each having a shape of a projection protruding outward. The respective external teeth 52a are arranged along the circumference direction of the ring gear 52 at intervals each having a spacing that can accommodate two balls 56 except for two adjacent external teeth 52a′ which are offset to have a spacing therebetween that can accommodate only one ball 56. In the state before the operation shown in FIG. 7, the offset two external teeth 52a′ get into the notched portion 51e on the straight portion 51d of the pipe 51, and the ball 56 at the forefront in the pipe 51 is sandwiched between these two external teeth 52a′ in contact to each other.

A gas generator storage section 51f that is slightly thicker than the pipe 51 is formed at the proximal end 51a of the pipe 51. The gas generator 53 is stored in the gas generator storage section 51f, and then fixed thereto by crimping a flange portion from the outside. At the time of sudden deceleration of the vehicle such as in the case of an emergency, the gas generator 53 ignites gunpowder according to a signal emitted from the sudden deceleration sensor (not shown) and supplies an injection gas pressure into the pipe 51 as shown in FIG. 8. The pipe 51 is configured to have a high air-tightness that can prevent the injection gas from leaking from the gas generator storage section 51f at the proximal end 51a to the notched portion 51e at the other end.

In a state before the operation of the pretensioner 11 shown in FIG. 7, the coil spring 54, the piston ball 55 and the fifteen balls 56 are stored in the pipe 51 in sequence from the gas generator 53. The balls 56 are spherical members formed of metal such as steel. The outer diameter of each ball 56 is slightly smaller than the inner diameter of the pipe 51 so that it can move relatively smoothly in the pipe 51. A forefront ball 56-1 is in contact with the offset two external teeth 52a′ of the ring gear 52.

The piston ball 55 is formed of resin such as silicone rubber. The piston ball 55 can be slid hermetically along an inner surface of the pipe 51 by being deformed and expanded after discharge of the injection gas, and hence can serve also as a seal which prevents gas from leaking toward the forefront side. In a state before the operation of the pretensioner 11 shown in FIG. 7, the coil spring 54 is arranged between the gas generator 53 and the piston ball 55, and applies an urging force to the piston ball 55 in the direction toward an opposite end of the pipe 51. The forefront ball 56-1 comes into contact with the offset two external teeth 52a′ of the ring gear 52 by the urging force applied by the coil spring 54.

A guide block 57 is mounted to an end of the straight portion 51d of the pipe 51. The guide block 57 is formed into a column shape with a distal end cut in an oblique direction. The oblique surface serves as a guide surface. The guide surface includes a first guide surface 57a and a second guide surface 57b. The first guide surface 57a is formed into an arcuate shape being substantially concentric with the ring gear 52 at an upper end portion of the guide block 57, and the ball 56 injected from the pipe 51 hits thereto when the pretensioner 11 is operated. On the other hand, the second guide surface 57b is formed into a planer shape and is formed so as to be separated gradually from the ring gear 52.

In the description shown above, the ring gear 52 and the pinion 17 constitute a driver for converting the movement of the accelerated balls 55, 56 into a force for rotating the torsion bar 7, which includes the plurality of balls 55, 56 arranged in the pipe 51 and accelerated by gas and the clutch to be coupled to the torsion bar 7 on the other axial side.

Subsequently, the operation of the pretensioner 11 will now be described. In the pretensioner 11 not in operation (the normal state) shown in FIG. 7, the ring gear 52 is retained at a fixed position on the side of the inner periphery of the pipe 51 by the plurality of shear pins (not shown) formed on a resin-made pretensioner cover 11 a (see FIG. 2). The ring gear 52 and the pinion 17 are not meshed with respect to each other. Therefore, the locking base 14 can rotate freely irrespective of the pretensioner 11.

Thereafter, when the state of collision of the vehicle is detected, a signal is transmitted to the gas generator 53. With this signal, the gas generator 53 is ignited and the injection gas pressure is supplied into the pipe 51 as shown in FIG. 8. The piston ball 55 which is the nearest to the gas generator 53 is pressed first by this injection gas pressure, and then the plurality of balls 56 are pressed in sequence by the pressing force from the piston ball 55. Then, the pressing force is transmitted to the front-most ball 56-1 (the ball which is in contact with the two external teeth 52a′ of the ring gear 52). Because the piston ball 55 is deformed and expanded by the gas pressure at this time, a sealing function is generated with respect to an inner surface of the pipe 51, and hence the gas does not escape toward the forefront side. Because the pipe 51 is configured to have a high air-tightness, the injection gas for driving the balls 56 by the piston ball 55 does not escape, and thus power loss of the pretensioner 11 is prevented.

When the pressing force is applied to the ring gear 52 by the pressing force of the balls 56, the shear pin (not shown) of the pretensioner cover 11a is sheared, and hence the ring gear 52 is disengaged and moved toward the pinion 17 side. Then, the internal teeth 52b of the ring gear 52 and the external teeth 17a of the pinion 17 are engaged, thereby being brought into a state in which the clutch is coupled. The ring gear 52 rotates about a coaxial core by a force of the balls 56 pressing the external teeth 52a. At the time before the ring gear 52 starts moving, the forefront ball 56-1 is in contact with the external teeth 52a′ of the ring gear 52 in a posture of giving the same a rotational force, and hence the ring gear 52 starts reliably rotating.

Furthermore, when the balls 55, 56 are pressed out in sequence upon reception of the injection gas pressure, the respective balls 56 engage between troughs of the external teeth 52a of the ring gear 52 in sequence. In this case, two balls 56 each engage with one trough of the ring gear 52. By the sequential engagement of these balls 56, the ring gear 52 rotates counterclockwise in FIG. 8. Because the external teeth 17a of the pinion and the internal teeth 52b of the ring gear mesh with each other, the rotation of the ring gear 52 is transmitted to the pinion 17, and hence both of them rotate in conjunction with each other. Because the pinion 17 is fixed to the locking base 14, the locking base 14 is rotationally driven together with the pinion 17. The state of the pretensioner 11 immediately after the operation as shown in FIG. 8 is by way of example, and the position of the piston ball 55 in the pipe 51 varies depending on the relation between the physical construction, the posture, or the like of the passenger and the seatbelt 3.

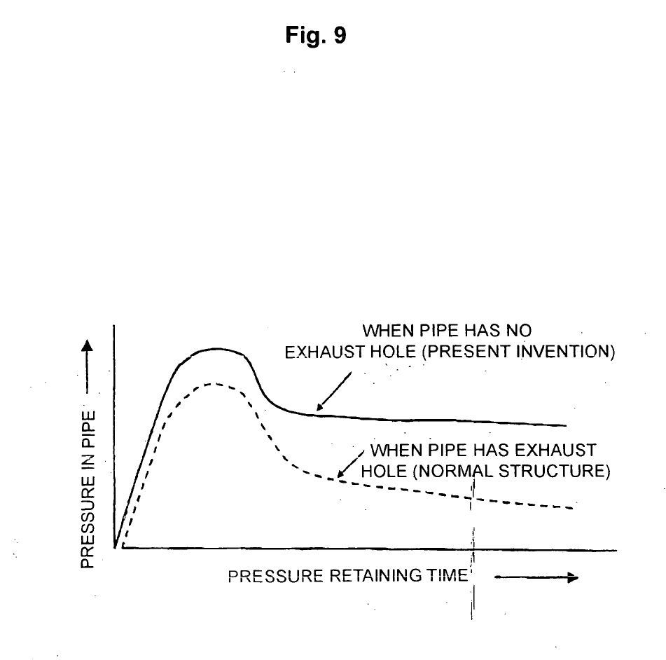

By the operation of the EA mechanism by the torsional deformation of the torsion bar 7, an impact applied by the seatbelt 3 to the passenger is absorbed and alleviated. Then, the injection gas pressure in the pipe 51 is sufficiently maintained for a certain time after the operation of the EA mechanism (the period in which the operation of the EA mechanism is required), and thus the drive force of the locking base 14 in the retracting direction is maintained. In other words, when the EA mechanism is in operation, the rotation in the seatbelt withdrawing direction is locked by the locking base 14. FIG. 9 is a drawing showing the behavior in which the injection gas pressure is maintained, and shows pressure characteristics of the pretensioner 11 in this modification. A case in which a gas releasing hole is provided for smoothing the EA operation as stated in the Japanese Unexamined Patent Application Publication No. 2002-120603 (incorporated by reference herein) is also shown for comparison. As seen from FIG. 9, in this modification, because the gas releasing hole is not provided on the pretensioner 11, the injection gas pressure in the pipe 51 is maintained for a while after the operation of the EA mechanism.

In the same manner as in the above-described first embodiment, when the pretensioner 11 is activated at the time of sudden deceleration of the vehicle in this modification, the rotational drive force in the seatbelt retracting direction is applied to the other axial side of the torsion bar 7 via the locking base 14 and maintains the restraint of the rotation of the other side of the locking base 14 and the torsion bar 7 in the seatbelt withdrawing direction for a certain time period until the injection gas pressure in the pipe 51 is lowered. Accordingly, the rotation of the locking base 14 and the torsion bar 7 on the other axial side in the seatbelt withdrawing direction at the time of sudden deceleration of the vehicle can be restricted by the operation of the pretensioner 11 by itself without the provision of the sub pawl 13L on the locking base 14. Thus, simplification of the structure of the seatbelt retractor and reduction of the number of components can be achieved.

Another modification to the first embodiment of the present invention may include, for example, a centrifugal pawl that can be used as a sub pawl for locking the locking base 14 at the time of sudden deceleration of the vehicle.

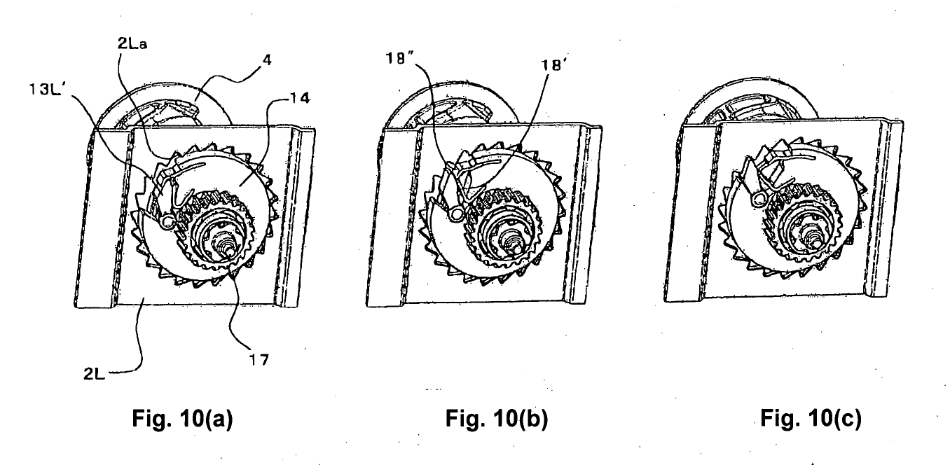

FIG. 10 is a drawing showing a configuration in which a centrifugal pawl is provided on the locking base 14. FIG. 10(a) is a drawing showing the centrifugal pawl in the unlocked state; FIG. 10(b) is the centrifugal pawl between the unlocked state and the locked state; and FIG. 10(c) is a drawing showing the centrifugal pawl in the unlocked state.

In FIG. 10, a centrifugal pawl 13L′ is swingably held on the locking base 14. The locking base 14 is provided with a locking spring member 18′ for applying an urging force to the centrifugal pawl 13L′ toward the outer periphery side of the locking base 14 and an unlocking spring member ˜″ to be engaged with a distal end of the centrifugal pawl 13L′ for applying an urging force to the centrifugal pawl 13L′ toward the inner periphery side of the locking base 14.

The centrifugal pawl 13L′ itself is formed of a material such as metal and has a sufficient mass. An urging force applied to the centrifugal pawl 13L′ by the unlocking spring member 18″ is adapted to be slightly larger than an urging force applied thereto by the locking spring member 18′. Therefore, in the state in which the locking base 14 is not rotating or in the state in which the locking base 14 is rotated to an extent of the normal state including the gentle deceleration of the vehicle, a resultant force of the urging force applied by the locking spring member 18′ and the centrifugal force applied to the centrifugal pawl 13L′ itself (both of these forces are applied in the direction toward the outer periphery side of the locking base 14) is smaller than the urging force applied by the unlocking spring member 18″. The unlocking spring member 18″ is continuously engaged with the centrifugal pawl 13L′ and maintains the centrifugal pawl 13L′ in the unlocked state (see FIG. 10(a)).

When the sudden rotational drive force is applied to the locking base 14 by the operation of the pretensioner 11, the centrifugal force applied to the centrifugal pawl 13L′ itself is abruptly increased. Thus, the resultant force of its centrifugal force and the urging force applied by the locking spring member 18′ overcomes the urging force applied by the unlocking spring member 18″ so that the centrifugal pawl 13L′ is disengaged from the unlocking spring member 18″ (see FIG. 10(b)). Thereafter, the centrifugal pawl 13L′ is brought into the locked state by being engaged with the internal teeth on the side wall on the outer peripheral side with respect to the locking base 14 by the resultant force (see FIG. 10(c)).

Even with this modification, when the pretensioner 11 is operated at the time of sudden deceleration of the vehicle, the rotation of the other axial sides of the locking base 14 and the torsion bar 7 in the seatbelt withdrawing direction can be restricted as in the case of the first embodiment.

The seatbelt retractor according to a second embodiment of the present invention will now be described below.

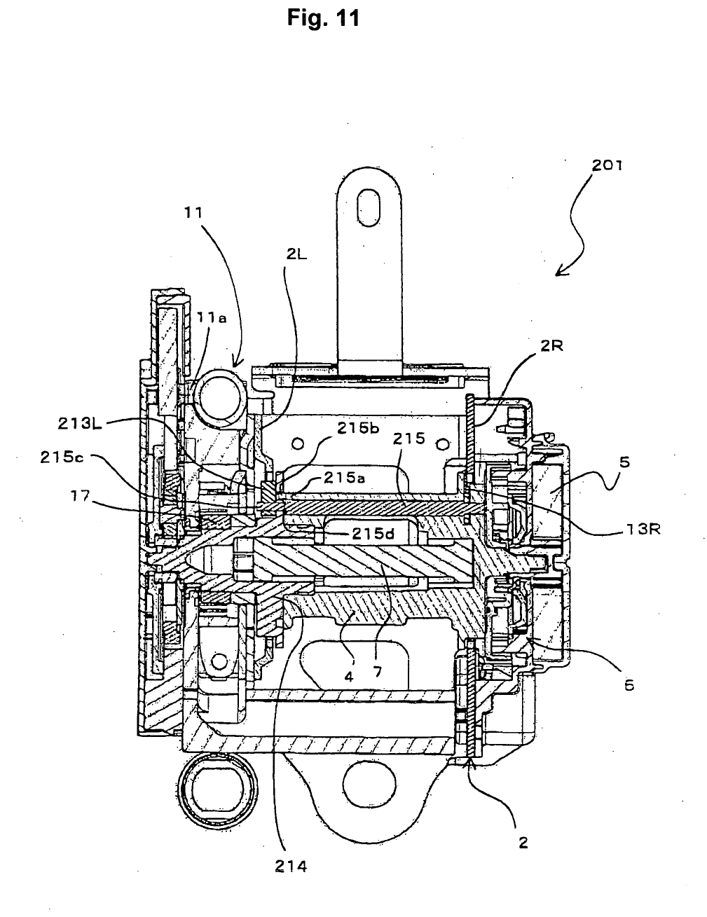

FIG. 11 is a vertical cross-sectional view showing a schematic structure of a seatbelt retractor 201 according to the second embodiment. The same parts as those in the first embodiment are represented by the same reference numerals and the description thereof are omitted as needed.

In FIG. 11, a sub pawl 213L is arranged at the same circumferential position as the main pawl 13R about the axis of the torsion bar 7. An extremity 215c of a camshaft 215 extending from the rotation axis of the main pawl 13R is passed through a locking base 214 and connected to the rotational center of the sub pawl 213L. The locking base 14 is provided with the spring member 18 at a position where the spring member 18 can apply a constant urging force to the sub pawl 213L toward the outer periphery side of the locking base 214 (see FIG. 4) in the same manner as the first embodiment.

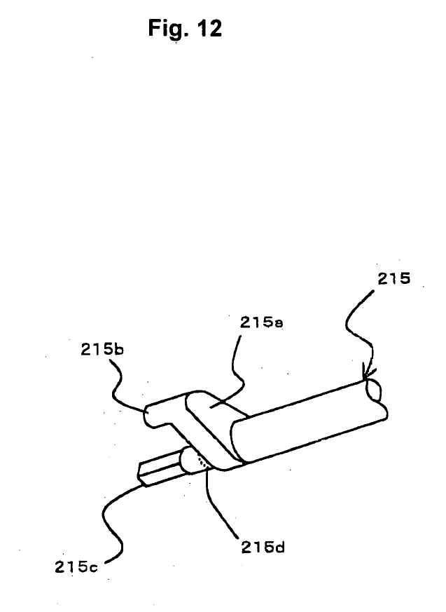

The extremity 215c of the camshaft 215 is formed so as to assume a square shape at the lateral cross-section at a portion fitted to the sub pawl 213L shown in FIG. 12. The sub pawl 213L rotates integrally with the main pawl 13R by being fitted and coupled tightly to the fitting portion of the extremity 215c. The main pawl 13R and the sub pawl 213L are interlocked in such a manner that when the main pawl 13R is in the unlocked state, the sub pawl 214L is also in the unlocked state, and when the main pawl 13R is in the locked state, the sub pawl 213L is in the locked state.

With this coupling, as long as a presumptive shearing portion 215d of the camshaft 215 is not sheared as described later, the locking base 214, the torsion bar 7 and the spool 4 rotate integrally and serve to retract/withdraw the seatbelt 3. The camshaft 215 is also provided with a coupling plate 215a and a cam pin 215b which are the same as the camshaft in the first embodiment.

The extremity 215c of the camshaft 215 is provided with the presumptive shearing portion 215d which is to be sheared at a predetermined time according to the applied load in the vicinity of the coupling plate 215a on the side of the sub pawl 213L. The presumptive shearing portion 215d of the camshaft 215 is set in advance to a shearing strength on the basis of the shape or the material so that the balance with the drive torque, which is generated by the pretensioner 11, results in the shearing behavior in a mode described later.

In the description above, the camshaft 215 constitutes a shear shaft provided so as to penetrate through the locking base 214 and the spool 4 in the axial direction as a common rotational axis, which is coupled respectively to the sub pawl 213L and the main pawl 13R. The camshaft 215 is provided with the presumptive shearing portion 215d which is to be sheared according to the applied load.

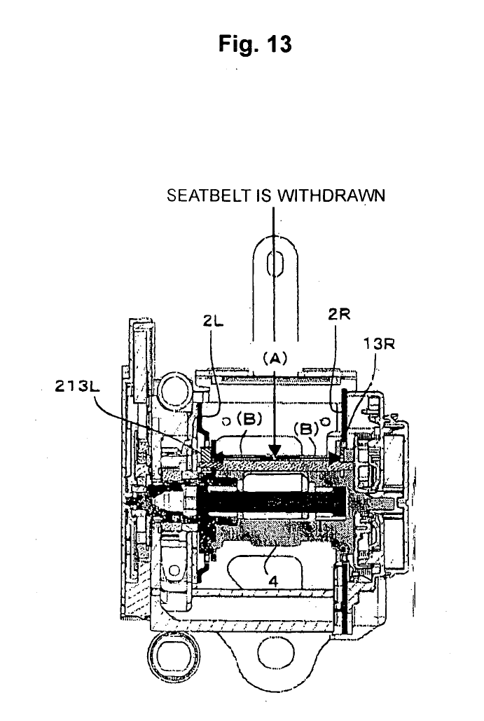

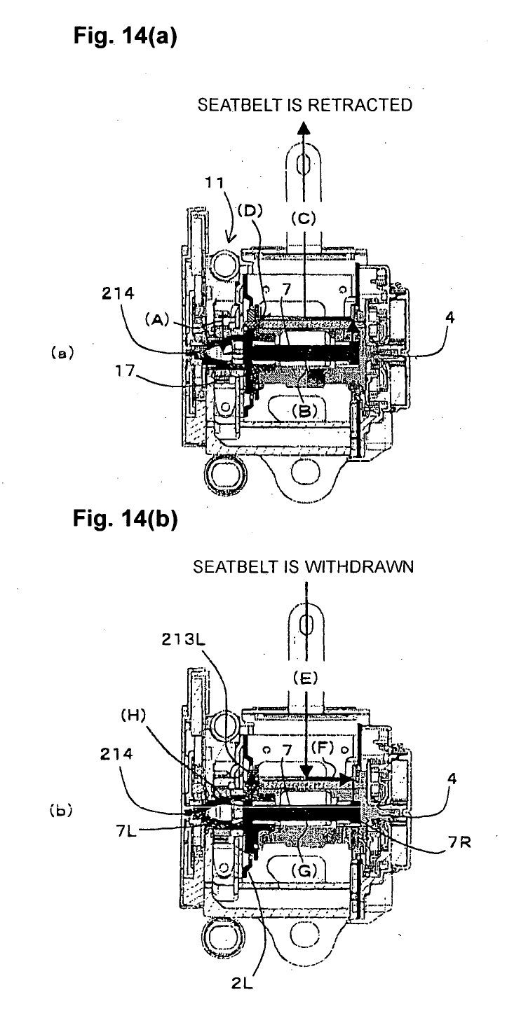

Referring now to FIG. 13 and FIG. 14, an operation and the effects of the seatbelt retractor 201 in the second embodiment with the configuration as described above will be described below. The arrows shown in FIG. 13 and FIG. 14 indicate a direction of the applied load.

FIG. 13 is a drawing showing the operation and effects of the seatbelt retractor 201 in the normal state. As shown in FIG. 13, the cam pin 215b is located within the circumferential groove of the locking base 214, and the presumptive shearing portion 215d of the camshaft 215 is in the substantially unsheared state (i.e., a state of not being shared). Both of the main pawl 13R and the sub pawl 213L are in the unlocked state so that the locking base 14, the torsion bar 7, and the spool 4 are integrated and are free to rotate. When the seatbelt 3 is not worn, the seatbelt 3 is completely retracted with the urging force applied by the spiral spring 5.

When the seatbelt 3 is withdrawn at a normal speed so as to be worn (see (A) in FIG. 13), the spool 4 is rotated in the seatbelt withdrawing direction, and hence the seatbelt 3 is smoothly withdrawn. After the tongue slidably provided on the seatbelt 3 (not shown) is inserted into and engaged with the buckle which is fixed to the vehicle body, the seatbelt 3 that is excessively withdrawn is retracted by the spool 4 by the urging force applied by the spiral spring 5. Hence, the seatbelt 3 fits the passenger to an extent that the seatbelt does not make him or her feel an uncomfortable constraint.

When an attempt is made to retract the seatbelt 3 abruptly, the lock activation mechanism 6 rotates the main pawl 13R toward the outer periphery side of the spool 4, and the sub pawl 213L is moved in conjunction therewith. Thus, the main pawl 13R and the sub pawl 213L engage with the internal teeth of the side walls 2R, 2L of the frame 2, respectively, by the operation of the deceleration sensor. With the engaging operation of the main pawl 13R and the sub pawl 213L as described above, the spool 4 and the locking base 214 are locked with the side walls 2R, 2L of the frame 2 (see (B) in FIG. 13), respectively, whereby the rotation of the seatbelt withdrawing direction is restricted. In the operation in the normal state, because the urging force is constantly applied to the sub pawl 213L by the spring member 18, an urging force is always applied both to the sub pawl 213R and the main pawl 13R interlocked therewith so as to keep both pawls in the locked state. However, the lock activation mechanism 6 controls to achieve adequate rotation by working against the urging force applied via the operating pin 13Ra.

FIG. 14 is a drawing showing the operation and effects of the seatbelt retractor 201 at the time of sudden deceleration of the vehicle as in the case of an emergency. As shown in FIG. 14, the pretensioner 11 is activated in response to the sudden deceleration, the rotational drive force is transmitted to the locking base 214 via the pinion 17 (see (A) in FIG. 14(a)). The rotational drive force is transmitted to the spool 4 via the torsion bar 7 (see (B) in FIG. 14(a)). The spool 4 is rotated by a predetermined amount to the seatbelt retracting direction (see (C) in FIG. 14(a)) to improve a force of constraint of the seatbelt 3 with respect to the passenger. At this time, the presumptive shearing portion 215d of the camshaft 215 is sheared at the time of sudden deceleration of the vehicle (see (D) in FIG. 14(b)) by the rotational drive force of the pretensioner 11 to release the interlocking/coupling between the main pawl 13R on the one side (the right side in FIGS. 14(a) and (b)) and the sub pawl 213L on the other side (the left side in FIGS. 14(a) and (b)), thereby releasing the connection between the spool 4 and the locking base 214.

Then, the passenger's body pulls the seatbelt 3 by a large force exceeding a predetermined value due to inertia (see (E) in FIG. 14(b)), and a large force is applied to the spool 4 in the seatbelt withdrawing direction (see (F) in FIG. 14(b)). Because the presumptive shearing portion 215d of the camshaft 215 is already sheared at this point in time, the sub pawl 213L comes into engagement with the internal teeth 2La of the side wall 2L on the outer peripheral side with respect to the locking base 214 by the urging force applied by the spring member 18 (see FIG. 4(c)) so that the locking base 214 is locked by the side wall, and hence the rotation of the seatbelt withdrawing direction is restricted.

Then, when the seatbelt 3 is withdrawn, the withdrawing torque is transmitted to the locking base 214 (see (G) in FIG. 14(b)) via the torsion bar 7, whereby a rotational displacement comes about in which the spool 4 is rotated relative to the locking base 214 in the seatbelt withdrawing direction. Thus, the main pawl 13R is rotated into the inner peripheral side of the spool 4 and is brought into the unlocked state (see FIG. 3(c)) by the operation of the cam mechanism described in conjunction with the first embodiment.

As a consequence, the portion 7R on the one axial side (the right side in FIGS. 14(a) (b)) of the torsion bar 7 coupled to the spool 4 is rotationally displaced relative to the portion on the other axial side (which is fixed to the locking base 214 locked by the sub pawl 13L, see (H) in FIG. 14(b)). This torsional deformation of the torsion bar 7 absorbs the passenger's kinetic energy, thereby restricting the load applied to the seatbelt 3.

Because the pretensioner 11 is located on the other axial side of the spool 4 and is coupled to the locking base 214, the operation of the EA mechanism is stabilized in which the portion 7R of the torsion bar 7 on one side is twisted and rotated relative to the portion 7L on the other side without being affected by the operation of the pretensioner 11.

In the manner described above, the seatbelt retractor 1 according to the second embodiment locks both the spool 4 coupled to one axial side of the torsion bar 7 and the locking base 214 coupled to the other axial side of the torsion bar in the normal state; unlocks the spool 4 on the one axial side of the torsion bar 7 for the torsional deformation of the torsion bar 7 at the time of sudden deceleration of the vehicle; and keeps only the locking base 214 on the other axial side in the locked state. Therefore, a stabilized EA operation is achieved without being affected by the operation of the pretensioner 11.

The priority application, Japanese Patent Application No. 2005-257407, filed on Sep. 6, 2005, including the specification, drawings, claims, and abstract, is incorporated herein by reference in its entirety.

Detailed configurations in the respective embodiments and the respective modifications described above are not intended to limit the contents of the present invention, and various modifications may be made in details within the scope of the present invention as a matter of course. The scope of the present invention is to be defined as set forth in the following claims.

What is claimed is;

1. A seatbelt retractor comprising:
a spool for retracting a seatbelt with one axial side and an other axial side;
a torsion bar arranged radially inside of the spool with one axial side and an other axial side, wherein the torsion bar is coupled to the spool at the one axial side of the torsion bar;
a pretensioner positioned on the other axial side of the spool for generating a rotational drive force for rotating the spool in a seatbelt retracting direction during a state of emergency; and
a relay locking mechanism configured for locking the spool with respect to a fixed-side member of a vehicle so as to restrict the rotation of the spool in a seatbelt withdrawing direction in the normal state and configured for unlocking the spool with respect to the fixed-side member while locking the other axial side of the torsion bar with respect to the fixed-side member so as to restrict the rotation of the torsion bar in the seatbelt withdrawing direction in the state of emergency.

2. The seatbelt retractor according to claim 1, further comprising a locking member positioned on the other axial side of the spool and connected to the other axial side of the torsion bar.

3. The seatbelt retractor according to claim 2, wherein the relay locking mechanism includes a first lock member for locking the locking member to the fixed-side member of the vehicle.

4. The seatbelt retractor according to claim 3, wherein the first lock member is a pawl provided rotatably on the locking member for performing a locking operation with respect to the locking member when a relative rotational displacement comes about between the locking member and the spool.

5. The seatbelt retractor according to claim 3, further comprising a shear pin provided on one of the first lock member and the spool so as to be locked with respect to the other of the first lock member and the spool, wherein the shear pin is configured to shear according to an applied load.

6. The seatbelt retractor according to claim 5, wherein the first lock member is a pawl which performs a locking operation with an urging force applied by a spring in the direction that locks the locking member when the shear pin is sheared.

7. The seatbelt retractor according to claim 3, wherein the relay locking mechanism includes a second lock member for locking the spool with respect to the fixed-side member of the vehicle.

8. The seatbelt retractor according to claim 7, wherein the second lock member is a pawl rotatably provided on the one axial side of the spool for performing the locking operation with respect to the spool according to a deceleration of the vehicle.

9. The seatbelt retractor according to claim 7, wherein the one axial side of the torsion bar and the one axial side of the spool are coupled so as to be capable of accepting a predetermined amount of relative rotational displacement therebetween.

10. The seatbelt retractor according to claim 9, wherein the second lock member is a pawl for releasing the locking operation with respect to the spool when the rotational displacement come about in which the spool rotates relative to the locking member in the seatbelt withdrawing direction.

11. The seatbelt retractor according to claim 10, wherein the locking member is formed with a cam groove on a surface opposing to the spool, and
wherein the second lock member includes a camshaft extending from a rotational axis and a cam pin which is to be engaged with the cam groove for causing the second lock member to rotate via the camshaft along the cam groove when a relative rotational displacement comes about between the spool and the locking member.

12. The seatbelt retractor according to claim 1, wherein the pretensioner comprises a gas generator, a conduit in fluid communication with the gas generator, a plurality of balls arranged in the conduit and configured to be moved by the gas, a clutch to be coupled to the other axial side of the torsion bar, and a mechanism for converting the movement of the balls into a force for rotating the torsion bar.

13. A seatbelt retractor comprising:
a spool for retracting a seatbelt with one axial side and an other axial side;
a torsion bar arranged radially inside of the spool with one axial side and an other axial side, wherein the torsion bar is coupled to the spool at one axial side of the torsion bar so as to be capable of accepting a predetermined amount of relative rotational displacement;
a locking base located on the other axial side of the spool and coupled to the other axial side of the torsion bar;
a pretensioner positioned on the other axial side of the spool for generating a rotational drive force for rotating the spool in a seatbelt retracting direction and for transmitting the rotational drive force to the locking base in a state of emergency;
a first pawl rotatably provided on the locking base for being locked with respect to a shear pin formed on the spool in the normal state, wherein the shear pin is configured to shear when a relative rotational displacement exceeding a predetermined amount comes about between the locking base and the spool by an operation of the pretensioner to lock the locking base with respect to a fixed side-member of the vehicle; and
a second pawl rotatably provided on the one axial side of the spool and provided with a cam mechanism for locking the spool with respect to the fixed-side member of the vehicle according to a deceleration of the vehicle in the normal state and releasing the locking operation with respect to the spool when a relative rotational displacement comes about between the locking base and the spool by the operation of the pretensioner.

14. The seatbelt retractor according to claim 13, wherein the cam mechanism includes a cam-shaft extending from a rotation axis of the second pawl and a cam pin which is to be engaged with a cam groove formed on the locking base.

15. A seatbelt retractor comprising:
a spool for retracting a seatbelt with one axial side and an other axial side;
a torsion bar arranged radially inside of the spool with one axial side and an other axial side, wherein the torsion bar is coupled to the one axial side of the spool;
a pretensioner positioned on the other axial side of the spool for generating a rotational drive force for rotating the spool in a seatbelt retracting direction in a state of emergency and for locking the other axial side of the torsion bar with respect to a fixed-side member so as to restrict the rotation in a seatbelt withdrawing direction of the torsion bar for a predetermined duration; and
a locking member for locking the spool with respect to the fixed-side member of the vehicle so as to restrict the rotation of the spool in the seatbelt withdrawing direction in the normal state and for unlocking the spool with respect to the fixed-side member in the state of emergency.

16. A seatbelt retractor comprising:
a spool for retracting a seatbelt with one axial side and an other axial side;
a torsion bar arranged radially inside of the spool with one axial side and an other axial side, wherein the torsion bar is coupled to the one axial side of the spool so as to be capable of accepting a predetermined amount of relative rotational displacement;
a locking base located on the other axial side of the spool and coupled to the other axial side of the torsion bar;
a first pawl rotatably provided on the locking base for locking the locking base with respect to a fixed-side member of the vehicle according to a deceleration of a vehicle;
a second pawl rotatably provided on the one axial side of the spool for locking the spool with respect to the fixed-side member of the vehicle according to the deceleration of the vehicle;
a pretensioner located on the other axial side of the spool for generating a rotational drive force to cause the spool to rotate in a seatbelt retracting direction and transmit the rotational drive force to the locking base in a state of sudden deceleration of the vehicle; and
a shear shaft provided so as to penetrate through the locking base and the spool in the axial direction and is coupled respectively to the first pawl and the second pawl.

17. The seatbelt retractor according to claim 16, wherein the shear shaft is provided with a presumptive shearing portion which is to be sheared according to an applied load.

18. The seatbelt retractor according to claim 17, wherein the presumptive shearing portion of the shear shaft is set to have a shearing strength to maintain the substantially unsheared state so as to keep a coupled state between the first pawl and the second pawl in the normal state, and to be sheared when the pretensioner is operated in the state of sudden deceleration of the vehicle on the basis of a force applied to the spool to cause the spool to rotate in the seatbelt retracting direction.

19. The seatbelt retractor according to claim 16, wherein the first pawl is applied with an urging force in a locking direction by a spring when the shear shaft is sheared.

20. The seatbelt retractor according to claim 16, wherein the second pawl releases a locking operation with respect to the spool when the shear shaft is sheared.

21. The seatbelt retractor according to claim 16, wherein the locking base is formed with a cam groove on a surface opposing the spool,
wherein the shear shaft comprises a cam pin which is to be engaged with the cam groove for causing the second pawl to be rotated via the shear shaft along the cam groove when the relative rotational displacement comes about between the spool and the locking base.

22. A seatbelt apparatus comprising:
a seatbelt for constraining a passenger;
a seatbelt retractor for withdrawably retracting one side of the seatbelt;
a tongue provided on the seatbelt; and
a buckle device for engagement with the tongue;
wherein the seatbelt retractor comprises:
a spool for retracting the seatbelt with one axial side and an other axial side;
a torsion bar arranged radially inside of the spool with one axial side and an other axial side; wherein the torsion bar is coupled to the one axial side of the spool;
a pretensioner positioned on the other axial side of the spool for generating a rotational drive force for rotating the spool in a seatbelt retracting direction in a state of sudden deceleration of the vehicle; and
a relay locking mechanism for locking the spool with respect to a fixed-side member of the vehicle so as to restrict the rotation of the spool in a seatbelt withdrawing direction in the normal state and for unlocking the spool with respect to the fixed-side member while locking the other axial side of the torsion bar with respect to the fixed-side member so as to restrict the rotation of the torsion bar in the seatbelt withdrawing direction in the state of sudden deceleration of the vehicle.
